(19) United States
(12) Patent Application Publication
(10) Pub. No.: US 2016/0007797 A1
(43) Pub. Date: Jan. 14, 2016

(54) WATER INTAKE STRUCTURE FOR A COFFEE MAKER

(71) Applicant: Yu-Yuan Lin, Tainan City (TW)

(72) Inventor: Yu-Yuan Lin, Tainan City (TW)

(21) Appl. No.: 14/559,924

(22) Filed: Dec. 4, 2014

(30) Foreign Application Priority Data
Jul. 9, 2014 (CN) 201420377472.4

(51) Int. Cl. A47J 31/46; A47J 31/40

(52) U.S. Cl. CPC A47J 31/46; A47J 31/407

(57) ABSTRACT

A water intake structure is provided for a coffee maker having a brewing unit and includes a water tank, a heating device, and a pump. The water tank includes a temperature transducer and is connected to a water intake pipe. The heating device includes a heating tube intercommunicated with the water tank. The pump is connected to the water intake pipe. The water intake pipe is connected to the brewing unit of the coffee maker. Two ends of the heating tube are located in the water tank. Water in the water tank can be guided via one of the two ends of the heating tube into the heating tube, heated by the heating tube, and then guided back into the water tank via the other end of the heating tube, thereby circulating and heating the water in the water tank.

### BACKGROUND OF THE INVENTION

The present invention relates to a water intake structure and, more particularly, to a water intake structure for a coffee maker.

Coffee is one of the favorite beverages of people in daily life. In order to drink coffee, coffee makers capable of rapidly heating and brewing coffee have been produced. A coffee maker generally includes a water intake unit, a heating unit, and a brewing unit. The water intake unit includes a water tank connected to a pump that guides cold water into the water tank. The heating unit includes a hot water chamber, a heating device, and another pump. The hot water chamber intercommunicates with the water tank and the brewing unit. The cold water guided into the hot water chamber is heated by the heating device, and the another pump pressurizes the hot water chamber to move the hot water into the brewing unit to brew coffee.

However, such a coffee maker requires both of the water tank and the hot water chamber, which increases the volume of the coffee maker and, thus, occupies a larger space. Furthermore, the coffee maker needs two pumps, leading to an increase in the costs.

Thus, a need exists for a novel coffee maker that mitigates and/or obviates the above disadvantages.

### BRIEF SUMMARY OF THE INVENTION

An objective of the present invention is to provide a coffee maker with a water intake structure having a reduced volume, occupying a smaller space, and having reduced costs.

Another objective of the present invention is to provide a coffee maker with a water intake structure, wherein a brewing unit of the coffee maker is automatically blow-dried after brewing coffee.

The above objectives are fulfilled by a water intake structure for a coffee maker. The coffee maker includes a brewing unit. The water intake structure includes a water tank, a heating device, and a pump. The water tank includes a temperature transducer and is connected to a water intake pipe. The heating device includes a heating tube intercommunicated with the water tank. The pump is connected to the water intake pipe. The water intake pipe is connected to the brewing unit of the coffee maker.

The water tank can include a cover.

Two ends of the heating tube are located in the water tank.

The coffee maker can further include a controller connected to the temperature transducer, the heating device, and the pump.

The pump guides all of hot water in the water tank into the brewing unit, and the controller controls the pump to pump air.

The brewing unit can include a coffee capsule seat adapted to receive a coffee capsule. The coffee capsule seat is connected to the water intake pipe.

By using the above structure, the heating device of the water intake structure of the coffee maker according to the present invention includes a heating tube intercommunicated with the water tank, and the two ends of the heating tube are located in the water tank. The water in the water tank can be guided via an end of the heating tube into the heating tube, heated by the heating tube, and then guided back into the water tank via the other end of the heating tube, thereby circulating and heating the water in the water tank. The coffee maker does not have to include a heating chamber, reducing the volume of the coffee maker and reducing the occupation space. Furthermore, the coffee maker according to the present invention includes only one pump to reduce the costs of the coffee maker.

After the pump has guided all of the hot water in the water tank into the brewing unit, the controller can control the pump to operate for a period of time (about 3-5 seconds) such that the pump can blow high-pressure air into the coffee capsule seat to blow-dry water drops remained in the coffee capsule seat, providing convenient use.

The present invention will become clearer in light of the following detailed description of illustrative embodiments of this invention described in connection with the drawings.

### DESCRIPTION OF THE DRAWINGS

FIG. 1 is a diagrammatic view of a coffee maker according to the present invention.

FIG. 2 is a diagrammatic view of the coffee maker with cold water filled into the coffee maker for heating purposes.

FIG. 3 is a diagrammatic view of the coffee maker illustrating output of coffee.

FIG. 4 is a diagrammatic view of the coffee maker illustrating drying of a coffee capsule seat by blowing air.

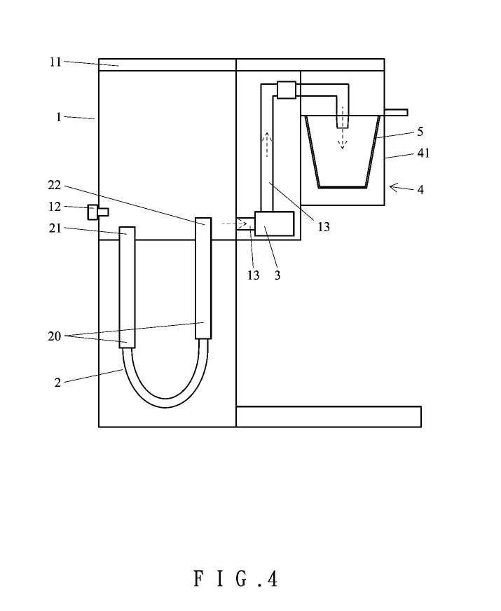

### DETAILED DESCRIPTION OF THE INVENTION

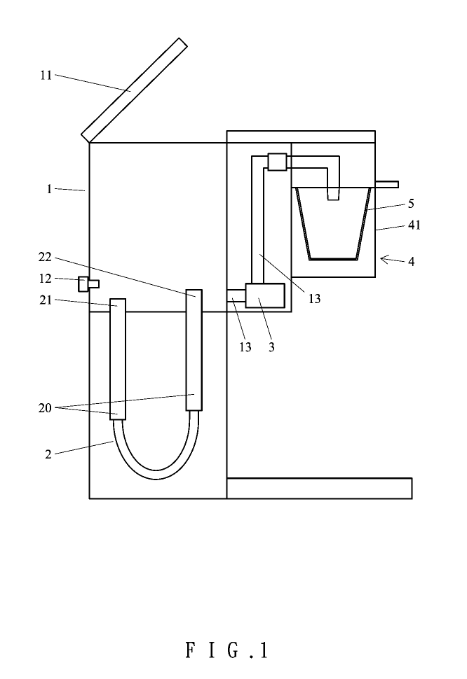

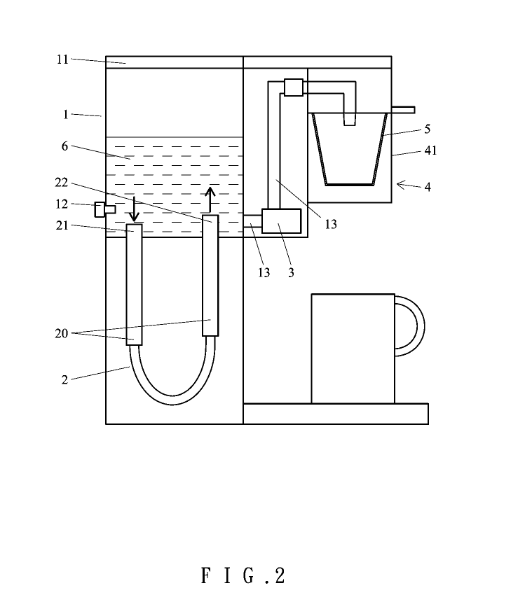

With reference to FIGS. 1 and 2, a water intake structure for a coffee maker according to the present invention includes a water tank 1, a heating device 2, and a pump 3. The water tank 1 includes a cover 11. The cover 11 can be opened to fill cold water 6 into the water tank 1. The water tank 1 includes a temperature transducer 12 and is connected to a water intake pipe 13.

The heating device 2 includes a heating tube 20 intercommunicated with the water tank 1. Two ends 21 and 22 of the heating tube 20 are located in the water tank 1. The water 6 in the water tank 1 is guided into the end 21 of the heating tube 20, is heated by the heating tube 20, and is then guided back into the water tank 1 via the other end 22. The cold water 6 in the water tank 1 is circulated and heated by the heating tube 20.

The pump 3 is connected to the water intake pipe 13. The water intake pipe 13 is connected to a brewing unit 4 of the coffee maker.

In this embodiment, the brewing unit 4 of the coffee maker includes a coffee capsule seat 41 adapted to receive a coffee capsule 5. A top of the coffee capsule seat 41 is connected to the water intake pipe 13. The temperature transducer 12, the heating device 2, and the pump 3 are connected to and controlled by a controller (not shown) to operate. In use, a user opens the cover 11 of the water tank 1, fills an appropriate amount of cold water 6 into the water tank 1, and then closes the cover 11. The controller controls the heating device 2 to heat, such that the cold water 6 in the water tank 1 is guided via the end 21 of the heating tube 20 of the heating device 2 into the heating tube 20 and then guided back into the water tank 1 via the other end 22 of the heating tube 20, thereby circulating and heating the water 6 in the water tank 1.

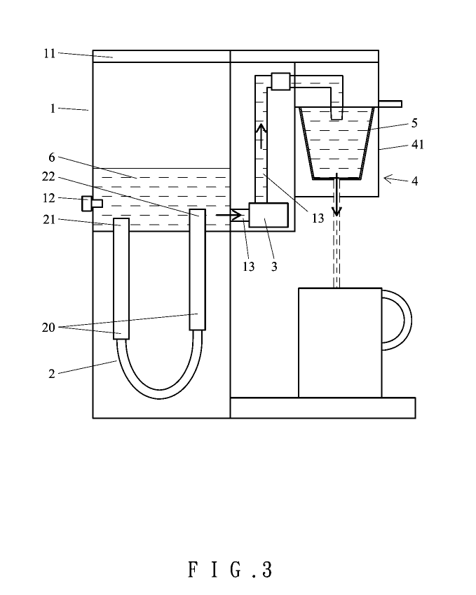

With reference to FIG. 3, when the temperature transducer 12 detects that the temperature of the hot water 6 in the water tank 1 has reached a preset value, the pump 3 is activated to guide all of the hot water 6 into the coffee capsule seat 41 of the brewing unit 4 via the water intake pipe 13 to thereby brewing the coffee capsule 5 in the coffee capsule seat 41. The coffee maker according to the present invention includes only one water tank 1 without the need of a heating chamber. Thus, the volume of the coffee maker can be reduced to reduce the occupation space. Furthermore, the coffee maker according to the present invention includes only one pump 3 to reduce the costs of the coffee maker.

With reference to FIG. 3, after the pump 3 has guided all of the hot water 6 in the water tank 1 into the brewing unit 4, the controller (not shown) can control the pump 3 to operate for a period of time (about 3-5 seconds) such that the pump 3 can blow high-pressure air into the coffee capsule seat 41 of the brewing unit 4 to blow-dry water drops remained in the coffee capsule seat 41, providing convenient use.

Although specific embodiments have been illustrated and described, numerous modifications and variations are still possible without departing from the scope of the invention. The scope of the invention is limited by the accompanying claims.

1. A water intake structure for a coffee maker having a brewing unit, with the water intake structure comprising a water tank, a heating device, and a pump, with the water tank including a temperature transducer and connected to a water intake pipe, with the heating device including a heating tube intercommunicated with the water tank, with the pump connected to the water intake pipe, and with the water intake pipe connected to the brewing unit of the coffee maker.

2. The water intake structure for a coffee maker as claimed in claim 1, wherein the water tank includes a cover.

3. The water intake structure for a coffee maker as claimed in claim 2, wherein the heating tube includes two ends located in the water tank.

4. The water intake structure for a coffee maker as claimed in claim 3, further comprising a controller, with the temperature transducer, the heating device, and the pump connected to the controller.

5. The water intake structure for a coffee maker as claimed in claim 4, wherein the pump guides all of hot water in the water tank into the brewing unit, and wherein the controller controls the pump to pump air.

6. The water intake structure for a coffee maker as claimed in claim 1 to claim 5, wherein the brewing unit includes a coffee capsule seat, wherein the coffee capsule seat is adapted to receive a coffee capsule, and wherein the coffee capsule seat is connected to the water intake pipe.
